(19) United States
(12) Patent Application Publication
(10) Pub. No.: US 2011/0004359 A1
(43) Pub. Date: Jan. 6, 2011

(54) Method and apparatus for determining a signal offset of a pitch rate sensor

(76) Inventors: Matthias Kretschmann, Regensburg (DE); Thomas Schweiger, Worth (DE); Martin Stratesteffen, Regensburg (DE)

Correspondence Address: King & Spalding LLP, 401 Congress Avenue, Suite 3200, Austin, TX, 78701, US

(21) Appl. No.: 12/445,976

(22) PCT Filed: Sep. 14, 2007
(86) PCT No.: PCT/EP2007/059696

§ 371 Date: Sep. 24, 2010

(30) Foreign Application Priority Data
Oct. 18, 2006 (DE) 10 2006 049 118.1

(51) Int. Cl. G06F 17/13

(52) U.S. Cl. 701/1

(57) ABSTRACT

In order to determine a signal offset (OFF_SIG) of a pitch rate sensor of a vehicle (2), a signal (OMEGA_TETA_SIG) from the pitch rate sensor is detected. Longitudinal acceleration (ACC) of the vehicle (2) is determined. A time derivative (ACC_DRV) of the longitudinal acceleration (ACC) is determined. A check is carried out in order to determine whether a magnitude of the time derivative (ACC_DRV) of the longitudinal acceleration (ACC) is less than a first predefined threshold value (THD_{—}1). The signal offset (OFF_SIG) of the pitch rate sensor is determined on the basis of the signal (OMEGA_TETA_SIG) from the pitch rate sensor if the magnitude of the time derivative (ACC_DRV) of the longitudinal acceleration (ACC) is less than the first predefined threshold value (THD_{—}1).

### CROSS-REFERENCE TO RELATED APPLICATIONS

This application is a United States national phase filing under 35 U.S.C. §371 of International Application No. PCT/EP2007/059696, filed Sep. 14, 2007 which claims priority to German Patent Application No. 10 2006 049 118.1, filed Oct. 18, 2006. The complete disclosure of the above-identified application is hereby fully incorporated herein by reference.

### TECHNICAL FIELD

The invention relates to a method and an apparatus for determining a signal offset of a pitch rate sensor. The pitch rate sensor is disposed in a vehicle. To determine the signal offset, a pitch rate sensor signal is acquired.

### BACKGROUND

The pitch rate sensor signal is indicative of a vehicle pitch rate. The pitch rate describes a rotation of the vehicle about its lateral axis which extends through a center of gravity of the vehicle. If the vehicle is not rotating about its lateral axis, the pitch rate sensor should produce a signal indicating that the pitch rate is zero. However, pitch rate sensors generally exhibit a signal misalignment or offset. The signal offset causes the pitch rate sensor, even in the absolute rest position, to indicate a non-zero pitch rate. If the signal offset is known, this can be taken into account for determining the pitch rate. Therefore, by knowing the signal offset, the pitch rate can be determined particularly precisely.

### SUMMARY

According to various embodiments, a method and an apparatus for determining a signal offset of a pitch rate sensor can be created which respectively provide a simple means of determining the signal offset of the pitch rate sensor in a particularly precise manner.

According to an embodiment, in a method for determining a signal offset of a pitch rate sensor of a vehicle,—a pitch rate sensor signal is acquired,—a longitudinal acceleration of the vehicle is determined,—a time derivative of the longitudinal acceleration is determined,—it is checked whether an absolute value of the time derivative of the longitudinal acceleration is less than a first predefined threshold value,—the signal offset of the pitch rate sensor is determined as a function of the pitch rate sensor signal if the absolute value if the time derivative of the longitudinal acceleration is less than the first predefined threshold value.

According to another embodiment, an apparatus for determining a signal offset of a pitch rate sensor of a vehicle, may be operable—to acquire a pitch rate sensor signal,—to determine a longitudinal acceleration of the vehicle,—to determine a time derivative of the longitudinal acceleration,—to check whether an absolute value of the time derivative of the longitudinal acceleration is less than a first predefined threshold value, and—to determine the signal offset of the pitch rate sensor as a function of the pitch rate sensor signal if the absolute value of the time derivative of the longitudinal acceleration is less than the first predefined threshold value.

According to a further embodiment, the pitch rate sensor signal can be acquired over a predefined period and the signal offset can be determined only as a function of portions of the pitch rate sensor signal which are acquired while the absolute value of the time derivative of the longitudinal acceleration is less than the first predefined threshold value. According to a further embodiment, the longitudinal acceleration of the vehicle can be determined using a longitudinal accelerometer. According to a further embodiment, the longitudinal acceleration of the vehicle can be determined as a function of a vehicle velocity of the vehicle and at least one wheel velocity of a wheel of the vehicle. According to a further embodiment, a wheel velocity of at least one wheel of the motor vehicle can be determined and wherein the signal offset of the pitch rate sensor can be determined as a function of the pitch rate sensor signal if an absolute value of the determined wheel velocity of the corresponding wheel is less than a second predefined threshold value. According to a further embodiment, a vehicle velocity can eb determined and wherein the signal offset of the pitch rate sensor can be determined as a function of the pitch rate sensor signal if an absolute value of the vehicle velocity determined is less than the second predefined threshold value. According to a further embodiment, a time derivative of the pitch rate sensor signal can be determined and wherein the signal offset of the pitch rate sensor can be determined as a function of the pitch rate sensor signal if an absolute value of the time derivative of the pitch rate sensor signal is less than a third predefined threshold value.

### BRIEF DESCRIPTION OF THE DRAWINGS

The invention will now be explained in greater detail with reference to the accompanying schematic drawings in which:

FIG. 1 shows a vehicle,

FIG. 2 shows a first program for determining the signal offset,

FIG. 3 shows a second program for determining the signal offset,

FIG. 4 shows two computing rules for determining the signal offset.

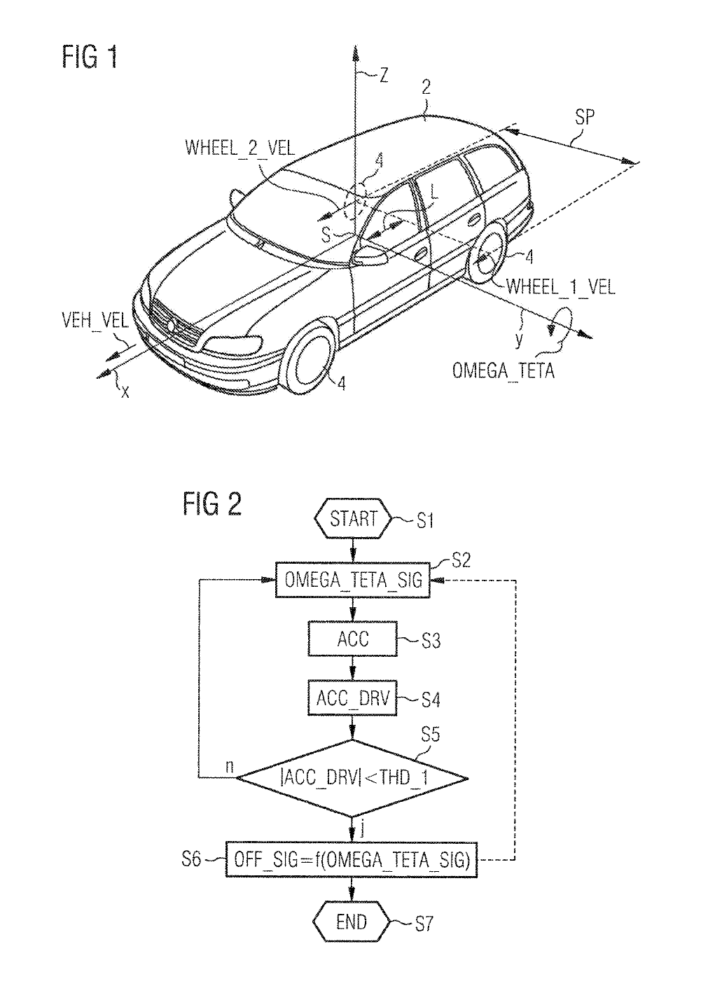

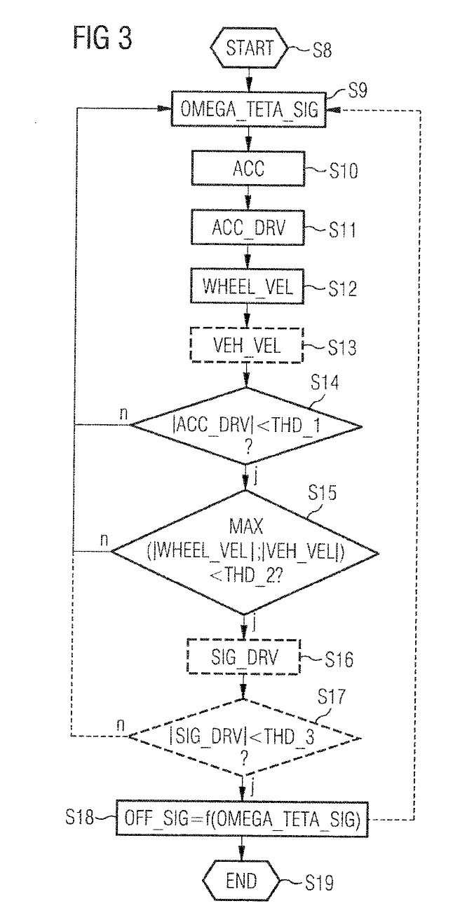

Elements of identical design or function are identified by the same reference characters throughout the Figures.

### DETAILED DESCRIPTION

According to various embodiments, in a method and an apparatus for determining a signal offset of a pitch rate sensor of a vehicle, a pitch rate sensor signal is acquired and a longitudinal acceleration of the vehicle is determined. A time derivative of the longitudinal acceleration is determined. It is checked whether an absolute value of the time derivative of the longitudinal acceleration is less than a first predefined threshold value. The signal offset of the pitch rate sensor is determined as a function of the pitch rate sensor signal if the absolute value of the time derivative of the longitudinal acceleration is less then the first predefined threshold value.

This enables the signal offset of the vehicle's pitch rate sensor to be determined. In particular, it enables the signal offset of the pitch rate sensor to be dynamically determined in spite of vehicle motion. This is conducive to precise determination of the signal offset of the pitch rate sensor. The signal offset of the pitch rate sensor can also be termed the pitch rate sensor offset.

In an embodiment of the method, the pitch rate sensor signal is detected over a predefined time. The signal offset is only determined as a function of the parts of the pitch rate sensor signal that are acquired while the absolute value of the time derivative of the longitudinal acceleration is less than the first predefined threshold value. A plurality of sub-intervals in which the signal offset is determined can therefore arise as a result. Averaging over the pitch rate sensor signal to determined the signal offset can extend over one or more time intervals, thereby enabling the signal offset of the pitch rate sensor to be determined in a particularly simple and precise manner.

In another embodiment of the method, the longitudinal acceleration of the vehicle is determined using a longitudinal accelerometer. This is conducive to particularly precise determination of the longitudinal acceleration of the vehicle and therefore of the signal offset of the pitch rate sensor.

In another embodiment of the method, the longitudinal acceleration of the vehicle is determined as a function of a vehicle velocity of the vehicle and at least one wheel velocity of a wheel of the vehicle. This can be conducive to particularly precise determination of the signal offset of the pitch rate sensor. It also enables a longitudinal accelerometer to be dispensed with or a longitudinal accelerometer signal to be checked for plausibility. The wheel velocity is the speed at which a center of gravity of the wheel moves relative to the ground over which the vehicle is traveling and in particular over which the corresponding wheel is rolling.

In another embodiment of the method, the wheel velocity of at least one wheel of the vehicle is acquired. The signal offset of the pitch rate sensor is determined as a function of the pitch rate sensor signal if an absolute value of the ascertained wheel velocity of the corresponding wheel is less than a second predefined threshold value. This can provide a simple means of detecting when the vehicle is stationary, and thus help to determine the signal offset of the pitch rate sensor in a particularly precise and steady-state manner while the vehicle is stationary.

In another embodiment of the method, the vehicle velocity is determined. The signal offset of the pitch rate sensor is determined as a function of the pitch rate sensor signal if the absolute value of the vehicle velocity determined is less than the second predefined threshold value. This can provide a simple means of detecting when the vehicle is stationary, and thus help to determine the signal offset of the pitch rate sensor in a particularly precise and steady-state manner while the vehicle is stationary.

In another embodiment of the method, a time derivative of the pitch rate sensor signal is determined. The signal offset of the pitch rate sensor is determined as a function of the pitch rate sensor signal if an absolute value of the time derivative of the pitch rate sensor signal is less than a third predefined threshold value. This can provide a simple means of detecting the signal offset in a particularly precise manner, as the signal offset is typically relatively constant. Should the pitch rate sensor signal therefore change markedly, the signal offset may regularly not be responsible. If the absolute value of the time derivative is therefore less than the third predefined threshold value, it can be assumed that the current pitch rate sensor signal merely represents the signal offset of the pitch rate sensor.

The different embodiments of the method are readily applicable to embodiments of the apparatus.

A vehicle 2 (FIG. 1) has a center of gravity S. A system of coordinates is specified such that an X-axis X is representative of a longitudinal axis of the vehicle 2, that a Y-axis Y is representative of a lateral axis of the vehicle 2 and that a Z-axis Z is representative of a vertical axis of the vehicle 2. The axes intersect at the center of gravity S. A rear axle of the vehicle 2 has a track width SP. The rear axle has an center distance L from the center of gravity S. In addition, the vehicle 2 preferably has four wheels 4. However, the vehicle 2 can also have more or fewer wheels 4.

A pitch rate OMEGA_TETA is indicative of a rotation of the vehicle 2 about the lateral axis of the vehicle 2. A vehicle velocity VEH_VEL represents a velocity of the vehicle 2. A wheel velocity WHEEL_1_VEL of a first rear wheel and a wheel velocity WHEEL_2_VEL of a second rear wheel represent longitudinal velocities of the corresponding wheel centers of gravity relative to the ground over which the vehicle is traveling. The wheel velocities are preferably determined as a function of radii of the wheels 4 and as a function of angular velocities with which the corresponding wheels 4 rotate about their own axle.

A pitch rate sensor provides a simple means of determining the pitch rate OMEGA_TETA of the vehicle 2. The pitch rate is preferably used to determine an orientation of the vehicle 2. In addition, a reference velocity of the vehicle velocity VEH_VEL can be determined e.g. as a function of the pitch rate OMEGA_TETA when negotiating a crest, a dip or entering an upgrade. This can, for example, help to ensure that an automatic braking system such as an ABS system is very precisely controllable.

By varying a temperature and/or by means of an aging process of the pitch rate sensor, a signal offset OFF_SIG of the pitch rate sensor can be generated and/or varied. The signal offset OFF_SIG is a zero shift which causes the pitch rate OMEGA_TETA to be signaled greater or smaller than it actually is. The pitch rate sensor is preferably a rotation rate sensor.

If it is known that the pitch rate sensor is at rest, the signal offset OFF_SIG can be determined by averaging the pitch rate sensor signal OMEGA_TETA_SIG. The signal offset OFF_SIG can then be taken into account for determining the pitch rate OMEGA_TETA, so that the pitch rate OMEGA_TETA is correctly determined even at different temperatures and/or for an older pitch rate sensor.

Pitching of the vehicle 2 with the pitch rate OMEGA_TETA is regularly caused by a variation of a longitudinal acceleration ACC of the vehicle 2. If the longitudinal acceleration ACC is approximately constant, it can be assumed that the actual pitch rate OMEGA_TETA is zero. In particular, the actual pitch rate OMEGA_TETA is proportional to a time derivative ACC_DRV of the longitudinal acceleration ACC of the vehicle 2.

A first program for determining the signal offset OFF_SIG of the pitch rate sensor is preferably stored on a storage medium of a control device of the vehicle 2. The first program is used to determine the signal offset OFF_SIG dynamically, i.e. also during driving of the vehicle 2. The first program is preferably launched in a step S1 in which variables are initialized if necessary.

In a step S2 a pitch rate sensor signal OMEGA_TETA_SIG is determined.

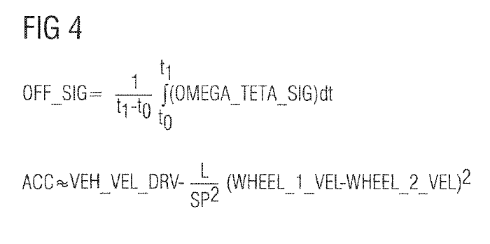

In a step S3 the longitudinal acceleration ACC of the vehicle 2 is determined. The longitudinal acceleration ACC of the vehicle 2 can be determined e.g. by a longitudinal accelerometer. Alternatively, the longitudinal acceleration can also be determined by means of the computing rule specified in FIG. 4 (FIG. 4). According to said computing rule, the longitudinal acceleration ACC can be determined as a function of a time derivative VEH_VEL_DRV of the vehicle velocity VEH_VEL, the wheel velocity WHEEL_1_VEL of the first rear wheel and the wheel velocity WHEEL_2_VEL of the second rear wheel.

In a step S4 the time derivative ACC_DRV of the longitudinal acceleration ACC of the vehicle 2 is determined.

In a step S5 it is checked whether an absolute value of the time derivative ACC_DRV is less than a first predefined threshold value THD_1. If the condition of step S5 is not fulfilled, processing is continued in step S2. If the conditions of step S5 is met, processing can be continued in a step S6.

In step S6, the signal offset OFF_SIG is determined as a function of the signal OMEGA_TETA_SIG of the pitch rate sensor, preferably according to the computing rule specified in FIG. 4. According to said computing rule, the pitch rate sensor signal OMEGA_TETA_SIG is determined over a period from a start time t₀ to an end time t₁. The start time t₀ and the end time t₁ are defined by the condition specified in step S5. Should the condition of step S5 no longer be fulfilled during the determining of the signal offset in step S6, the first program is interrupted. The signal offset OFF_SIG is preferably determined over a longer period in which the determining of the signal offset OFF_SIG is frequently interrupted. However, only the portions of the pitch rate sensor signal OMEGA_TETA_SIG during the determining of which the condition of step S5 is fulfilled are used for determining the signal offset OFF_SIG. As an alternative to averaging the pitch rate sensor signal OMEGA_TETA_SIG over time, the individual values comprising the pitch rate sensor signal OMEGA_TETA_SIG can also be averaged over the total number of values obtained. Alternatively, the averaging can be performed by a low-pass filter.

The first program can be terminated in a step S7. However, the first program is preferably executed regularly during operation of the vehicle 2.

Alternatively or additionally, a second program for determining the signal offset OFF_SIG can be stored on the storage medium of the control device. The second program is used to determine the signal offset OFF_SIG of the pitch rate sensor reliably and precisely when the vehicle 2 is stationary. For example, the second program enables the signal offset OFF_SIG to be determined very precisely if the vehicle 2 is being transported, e.g. on a ferry and/or a transporter train. The second program is preferably launched in a step S8 in which variables are initialized if necessary.

The pitch rate sensor signal OMEGA_TETA_SIG is acquired in a step S9.

The longitudinal acceleration ACC of the vehicle 2 is determined in a step S10.

The time derivative ACC_DRV of the longitudinal acceleration ACC of the vehicle 2 is determined in a step S11.

In a step S12, a wheel velocity WHEEL_VEL of at least one of the wheels 4 of the vehicle 2 is determined. The wheel velocities WHEEL_VEL of all the wheels 4 are preferably determined, in particular the wheel velocity WHEEL_1_VEL of the first rear wheel and the wheel velocity WHEEL_2_VEL of the second rear wheel.

In addition, the vehicle velocity VEH_VEL can be determined in a step S13. This is particularly advantageous when the longitudinal velocity VEH_VEL of the vehicle 2 in known independently of the wheel velocity WHEEL_VEL of the wheels 4, e.g. when using an ABS system in the vehicle 2.

In a step 514 it is checked whether the absolute value of the time derivative ACC_DRV of the longitudinal acceleration ACC is less than the first predefined threshold value THD_1. If the condition of step 514 is not fulfilled, processing is continued again in step S9. If the condition of step S14 is fulfilled, processing is continued in a step S15.

In step S15, a maximum selection MAX is determined from the absolute values of the wheel velocities WHEEL_VEL of the wheels 4 and the absolute value of the longitudinal velocity VEH_VEL of the vehicle 2. In other words, a check is performed to ascertain which absolute value of the wheel velocities WHEEL_VEL or of the longitudinal velocity VEH_VEL is the greatest. It is then checked whether the greatest of the absolute values is less than a predefined second threshold value THD_2. If the condition of step S15 is not fulfilled, processing is continued again in step S9. If the condition of step S15 is fulfilled, processing can be continued in a step S16 or a step S18.

In step S16, a time derivative SIG_DRV of the pitch rate sensor signal OMEGA_TETA_SIG is additionally determined.

If the time derivative SIG_DRV of the pitch rate sensor signal OMEGA_TETA_SIG was determined in step S16, it can be checked in a step 517 whether an absolute value of the time derivative SIG_DRV of the pitch rate sensor signal OMEGA_TETA_SIG is less than a third predefined threshold value. This is based on the knowledge that the signal offset OFF_SIG generally makes a constant contribution to the pitch rate sensor signal OMEGA_TETA_SIG. Should therefore the time derivative SIG_DRV of the pitch rate sensor signal OMEGA_TETA_SIG be equal to or greater than the third predefined threshold value THD_3, the current pitch rate sensor signal OMEGA_TETA_SIG may not only be the signal offset OFF_SIG of the pitch rate sensor. If the condition of step S17 not fulfilled, processing is continued again in step S9. If the condition of step S17 is fulfilled, processing is continued in step S18.

In step S18,the signal offset OFF_SIG is determined as a function of the pitch rate sensor signal OMEGA_TETA_SIG in accordance with step S6 of the first program.

The second program can be terminated in a step S19. The second program is preferably executed regularly during operation of the vehicle 2.

1. A method for determining a signal offset of a pitch rate sensor of a vehicle, the method comprising the steps of:
acquiring a pitch rate sensor signal,
determining a longitudinal acceleration of the vehicle,
determining a time derivative of the longitudinal acceleration,
checking whether an absolute value of the time derivative of the longitudinal acceleration is less than a first predefined threshold value,
determining the signal offset of the pitch rate sensor as a function of the pitch rate sensor signal if the absolute value if of the time derivative of the longitudinal acceleration is less than the first predefined threshold value.

2. The method according to claim 1, wherein the pitch rate sensor signal is acquired over a predefined period and the signal offset is determined only as a function of portions of the pitch rate sensor signal which are acquired while the absolute value of the time derivative of the longitudinal acceleration is less than the first predefined threshold value.

3. The method according to claim 1, wherein the longitudinal acceleration of the vehicle is determined using a longitudinal accelerometer.

4. The method according to claim 1, wherein the longitudinal acceleration of the vehicle is determined as a function of a vehicle velocity of the vehicle and at least one wheel velocity of a wheel of the vehicle.

5. The method according to claim 1, wherein a wheel velocity of at least one wheel of the motor vehicle is determined and wherein the signal offset of the pitch rate sensor is determined as a function of the pitch rate sensor signal if an absolute value of the determined wheel velocity of the corresponding wheel is less than a second predefined threshold value.

6. The method according to claim 1, wherein a vehicle velocity is determined and wherein the signal offset of the pitch rate sensor is determined as a function of the pitch rate sensor signal if an absolute value of the vehicle velocity determined is less than the second predefined threshold value.

7. The method according to claim 1, wherein a time derivative of the pitch rate sensor signal is determined and wherein the signal offset of the pitch rate sensor is determined as a function of the pitch rate sensor signal if an absolute value of the time derivative of the pitch rate sensor signal is less than a third predefined threshold value.

8. An apparatus for determining a signal offset of a pitch rate sensor of a vehicle, which is operable
to acquire a pitch rate sensor signal,
to determine a longitudinal acceleration of the vehicle,
to determine a time derivative of the longitudinal acceleration,
to check whether an absolute value of the time derivative of the longitudinal acceleration is less than a first predefined threshold value,
to determine the signal offset of the pitch rate sensor as a function of the pitch rate sensor signal if the absolute value of the time derivative of the longitudinal acceleration is less than the first predefined threshold value.

9. The apparatus according to claim 8, wherein the apparatus is further operable to acquire the pitch rate sensor signal over a predefined period and to determine the signal offset only as a function of portions of the pitch rate sensor signal which are acquired while the absolute value of the time derivative of the longitudinal acceleration is less than the first predefined threshold value.

10. The apparatus according to claim 8, comprising a longitudinal accelerometer determining the longitudinal acceleration of the vehicle.

11. The apparatus according to claim 8, wherein the apparatus is further operable to determine the longitudinal acceleration of the vehicle as a function of a vehicle velocity of the vehicle and at least one wheel velocity of a wheel of the vehicle.

12. The apparatus according to claim 8, wherein the apparatus is further operable to determine a wheel velocity of at least one wheel of the motor vehicle and to determine the signal offset of the pitch rate sensor as a function of the pitch rate sensor signal if an absolute value of the determined wheel velocity of the corresponding wheel is less than a second predefined threshold value.

13. The apparatus according to claim 8, wherein the apparatus is further operable to determine a vehicle velocity and to determine the signal offset of the pitch rate sensor as a function of the pitch rate sensor signal if an absolute value of the vehicle velocity determined is less than the second predefined threshold value.

14. The apparatus according to claim 8, wherein the apparatus is further operable to determine a time derivative of the pitch rate sensor signal and to determine the signal offset of the pitch rate sensor as a function of the pitch rate sensor signal if an absolute value of the time derivative of the pitch rate sensor signal is less than a third predefined threshold value.
